(19) United States
(12) Patent Application Publication
(10) Pub. No.: US 2007/0218960 A1
(43) Pub. Date: Sep. 20, 2007

(54) Combined electric iron and audio device

(76) Inventor: Noel Nunez Bernardino, Bacolod City (PH)

Correspondence Address: BAY AREA INTELLECTUAL PROPERTY GROUP, LLC, PO BOX 210459, SAN FRANCISCO, CA, 94121-0459, US

(21) Appl. No.: 11/385,410

(22) Filed: Mar. 20, 2006

(51) Int. Cl. H04M 1/00

(52) U.S. Cl. 455/575.1

(57) ABSTRACT

A combined iron and audio device is described, having an audio device incorporated into the housing of an electric iron. The audio device can be any audio playing device (e.g., an AM/FM radio receiver, a satellite radio receiver, a radio, cassette player, USB audio player, and an MP3 player, etc.). The controls of the audio device may be located on one of the exposed surfaces of the housing and/or the audio device may be controlled by a wireless remote controller.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FEDERALLY SPOSORED RESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to electronic enhancements to electric clothing irons. More particularly, the invention relates to combining an audio playing device into an otherwise conventional iron.

### BACKGROUND OF THE INVENTION

It is common for a person ironing cloths to be listening to a consumer audio playing device, such as a radio, cassette player, MP3 player, etc. Having a separate consumer audio playing device is often inconvenient and costly.

In view of the foregoing, there is a need for an electric iron that functionally combines a consumer audio playing device and an electric iron.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side, transparent sectional view of an exemplary combined iron and audio playing device, in accordance with an embodiment of the present invention;

FIG. 2 illustrates a side view of an exemplary combined iron and radio device, in accordance with an embodiment of the present invention; and

FIG. 3 illustrates an exemplary rear view of the combined iron and radio device shown in FIG. 1, in accordance with an embodiment of the present invention.

Unless otherwise indicated illustrations in the figures are not necessarily drawn to scale.

### SUMMARY OF THE INVENTION

To achieve the purpose of the invention and in accordance with an embodiment, a combination device is described, comprising an audio device incorporated into the housing of an electric iron. The audio device is any audio device (e.g., without limitation, an AM/FM radio receiver, a satellite radio receiver, a radio, cassette player, an MP3 player, etc.)

In one embodiment, the controls of the audio device (for example, without limitation, volume, on/off, tuning, and play/stop, etc.) are located on one of the exposed surfaces of the housing. In another embodiment, the audio device may be controlled by a wireless remote controller. In another embodiment, the audio device may have speaker(s) located on the exposed surfaces of the housing. The audio device and all its components are preferably protected from water damage. The audio device may also have a jack to plug in headphones or wireless headphones.

In another embodiment, the audio device may have a battery compartment incorporated into the housing. The power for the audio device may also be provided by a power converting circuit, which converts the electrical power used by the iron into a form suitable for use in the audio device.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionally of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

An aspect of the invention is to incorporate an audio playing device, such as, without limitation, an AM/FM radio receiver, satellite radio receiver, radio, cassette player, MP3 player, USB audio player, etc., into the housing of an electric iron so that during use thereof the audio entertainment can be enjoyed by the user.

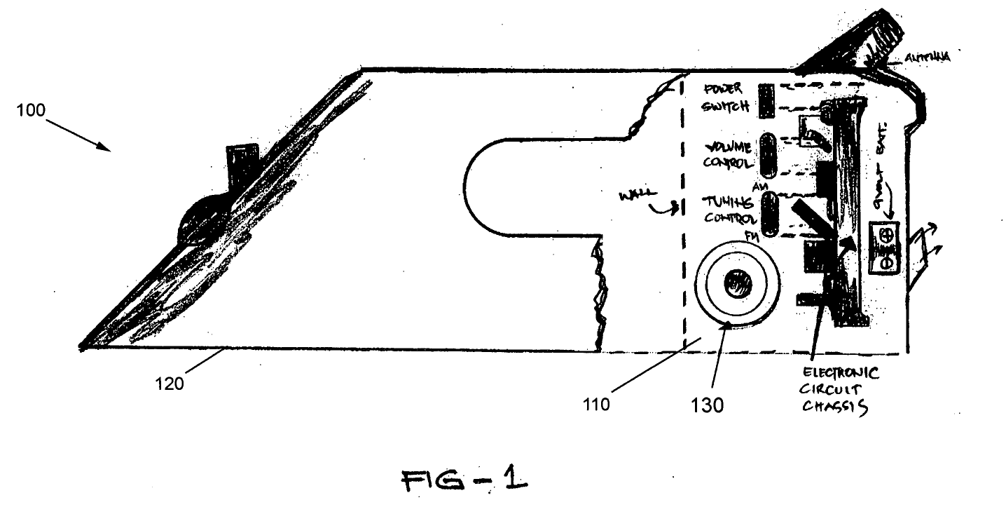

FIG. 1 illustrates a side, transparent sectional view of an exemplary combined iron an audio playing device 100, in accordance with an embodiment of the present invention. An audio playing device section 110 (the audio section being indicated by way clarity with a dashed line delineated transparent section revealing internal components thereof) is shown as a radio functionally incorporated into an iron 120; however any suitable audible entertainment device may be implemented. The audio playing device is a self contained and fully operational entertainment device and is preferably positioned in an accessible location such as, without limitation, at the top frame at the back of the iron housing. All required controls (e.g., without limitation, volume, on/off, tuning, play/stop, etc.) are conveniently made accessible and all associated electronics (not shown) are preferable comprised within iron 120 and a speaker 130 is located at an exposed surface that does not obstruct usage of the iron. In another embodiment, all exposed and internal parts of the audio device are protected from water damage by known techniques. For example, the mounting of speaker 130 is preferably made to be water resistant according to known techniques (e.g., without limitation, a silicon sealer applied where the speaker contacts the outer wall of the iron enclosure) so that the speaker and/or internal electronics are not harmed by water or humidity exposure. Some alternate embodiments of the present invention (not shown) further comprise a jack to plug in headphones, and yet other embodiments may not include a speaker and only have a headphone jack. Another alternate embodiment of the present invention (not shown) is fitted with wireless speakers and wireless headphones. Those skilled in the art will readily recognize, in light of the present teachings, a multiplicity of alternate and suitable approaches to properly incorporate an audio playing device and associated controls and components into an otherwise conventional iron. For example, without limitation, some embodiments of the present invention may be configured to have no manual controls of the audio playing device visible, but, instead, use a conventional wireless remote controller system (e.g., IR, UHF, etc.)

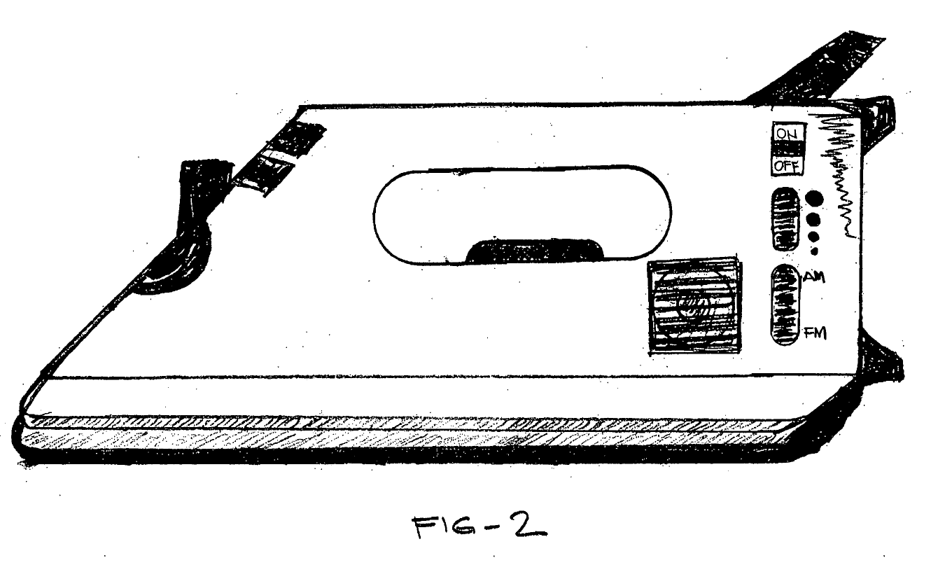

FIG. 2 illustrates a side view of an exemplary combined iron and radio device, in accordance with an embodiment of the present invention similar to that shown in FIG. 1, but more clearly shown without the sectional dashed line.

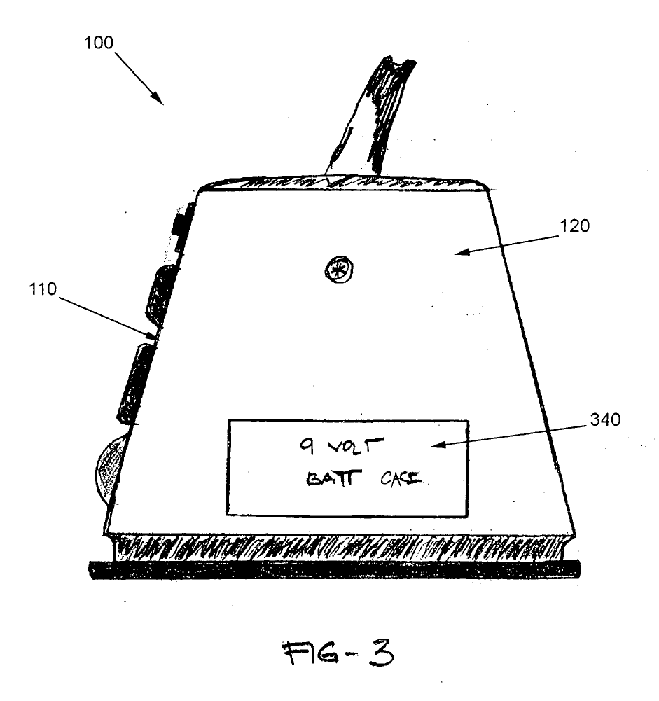

FIG. 3 illustrates a exemplary rear view of the combined iron and radio device shown in FIG. 1, in accordance with an embodiment of the present invention. In the example shown, a battery compartment 340 is incorporated into the back housing frame of iron 120 for storing an electrical power source that powers audio playing device 110. Those skilled in the art will readily recognize, in light of the present teachings, a multiplicity of alternate and suitable approaches to properly incorporate a power source for the audio playing device into an otherwise conventional iron. For example, without limitation, some embodiments of the present invention may be configured to have no replaceable battery compartment, but, instead, be powered off of the electrical power that powers the iron via a power converting circuit and/or be provided with a secondary battery power source that is contained within the iron and recharged using conventional recharging means.

Having fully described at least one embodiment of the present invention, other equivalent or alternative methods of combining an audio device into an electric iron according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A combined iron and audio device, comprising:
an electric iron having a housing;
an audio device configured into the housing;
a control system for the audio device, said control system being configured to operably control said audio device; and
a power source to power the audio device.

2. The combined iron and audio device of claim 1, in which the audio device is selected from the group consisting of an AM/FM radio receiver, a satellite radio receiver, a radio, a cassette player, USB audio player and an MP3 player.

3. The combined iron and audio device of claim 1, in which the control system comprises controls, which controls include a volume control, a on/off control, a tuning control, or a play/stop control.

4. The combined iron and audio device of claim 3, in which at least one control of the controls is disposed in or on an exposed surface of the housing.

5. The combined iron and audio device of claim 1, in which the control system comprises wireless remote control receiver operable for receiving control commands from a corresponding wireless remote control transmitter.

6. The combined iron and audio device of claim 1, further comprising means for protecting the audio device and all its components from water damage.

7. The combined iron and audio device of claim 1, further comprising a jack to plug in headphones and wireless headphones.

8. The combined iron and audio device of claim 1, in which the power source is a battery.

9. The combined iron and audio device of claim 8, further comprising a battery compartment operable for safely holding the battery in cooperation with the housing.

10. The combined iron and audio device of claim 1, in which the power source comprises a power converting circuit, the circuit converting the electrical power used by the iron into a form suitable for use in the audio device.

11. The combined iron and audio device of claim 1, in which the audio device is located in the back side of the iron housing.

12. The combined iron and audio device of claim 1, further comprising an audio output unit that is configured to receive output audio signals from said audio device, said audio output unit being operable to communicate to a user audio signals based on the output audio signals.

13. The combined iron and audio device of claim 12, in which said audio output unit is a speaker configured into the housing such that the audio output of the speaker can be made audible to the user.

14. The combined iron and audio device of claim 12, in which said audio output unit is a wireless speaker configured such that the audio output of the wireless speaker can be made audible to the user.

15. The combined iron and audio device of claim 1, in which the control system is configured to control the audio device in response to usage of the iron.

16. A combined iron and audio device, comprising:
an electric iron having a housing;
means for configuring an audio device into the housing;
means for controlling said audio device; and
means for powering the audio device.
